(19) United States
(12) Patent Application Publication
(10) Pub. No.: US 2015/0271110 A1
(43) Pub. Date: Sep. 24, 2015

(54) AUTOMATED STATUS BASED CONNECTION HANDLING

(71) Applicant: Samsung Electronics Co., Ltd., Suwon City (KR)

(72) Inventor: Craig Murray, San Jose, CA (US)

(73) Assignee: Samsung Electronics Co., Ltd., Suwon City (KR)

(21) Appl. No.: 14/222,562

(22) Filed: Mar. 21, 2014

(51) Int. Cl. H04L 12/58; H04W 4/14

(52) U.S. Cl. CPC H04L 51/02; H04W 4/14

(57) ABSTRACT

A connection handling system such as a mobile device allows selection of status indicators on a per channel basis. Status indicators may include states such as busy, unavailable, in a meeting, in a theater, or on vacation. Channels may include calls, text messages, and email messages. Connection requests received at the connection handling system may be handled by rules specified for particular status indicators and particular channels. In some instances, phone calls may be handled by silencing the ringer, suppressing voice mail notifications, responding to the caller with an automated caller specific and/or status specific reply that includes an override code that allows the caller to break through if the call is urgent. Status indicator selection may be provided on settings pages, application pages, or on a lock screen of a mobile device.

### TECHNICAL FIELD

The present disclosure relates to handling of connection requests using automated status based responses.

### BACKGROUND

Connection handling systems typically provide rudimentary routing and response mechanisms to all connection requests. In some examples, incoming calls or messages may be silenced and sent to an inbox at device. Alternatively, incoming calls and messages may be handled by responding with an automated and uniform reply. In some implementations, calls and messages may all be sent to a log while user notifications may be suppressed or silenced.

In still other examples, connection handling devices such as mobile devices may include a sleep mode, quiet mode, airplane mode, or silent mode that prevents connection requests from disturbing a user. These modes may or may not respond to connection requests with automated response messages.

However, mechanisms included in a variety of devices for handling connection requests are limited. Consequently, it is desirable to provide improved mechanisms for controlling multi-dimensional perspectives.

### BRIEF DESCRIPTION OF THE DRAWINGS

The disclosure may best be understood by reference to the following description taken in conjunction with the accompanying drawings, which illustrate particular embodiments.

FIGS. 1A-1B illustrate one example of a status screen that may be used with a connection handling system.

FIG. 2 illustrates one example of technique setting status for a status based connection handling mechanism.

FIG. 3A illustrates one example of a technique handling a call request.

FIG. 3B illustrates one example of a device for handling a call request.

FIG. 4 illustrates one example of a notification system.

FIG. 5 illustrates another example of a technique for whitelist and override handling.

FIG. 6 illustrates one example of a status based connection handling system.

### SUMMARY

An embodiment of a method includes: receiving a selection of a first status indicator for a first communication channel; receiving a selection of a second status indicator for a second communication channel; receiving a connection request on the first communication channel from a contact; selecting a first automated response message based on the first status indicator and the first communication channel, where the first automated response message corresponds to the first status indicator for the first communication channel; and automatically responding to the contact with the first automated response message by using a processor included in the device.

An embodiment of a device includes: a processor, and a memory coupled to the processor, where the memory is configured to store one or more programs that includes: instructions for receiving a selection of a first status indicator for a first communication channel, the selection received from a user of a device; instructions for receiving a selection of a second status indicator for a second communication channel; instructions for receiving a connection request on the first communication channel from a contact; instructions for selecting a first automated response message based on the first status indicator and the first communication channel, where the first automated response message corresponds to the first status indicator for the first communication channel; and instructions for automatically responding to the contact with the first automated response message.

An embodiment of a non-transitory processor-readable medium with an executable program stored thereon, where the program when executed on a processor performs a method that includes: receiving a selection of a first status indicator for a first communication channel, the selection received from a user of a device; receiving a selection of a second status indicator for a second communication channel; receiving a connection request on the first communication channel from a contact; selecting a first automated response message based on the first status indicator and the first communication channel, where the first automated response message corresponds to the first status indicator for the first communication channel; and automatically responding to the contact with the first automated response message.

An embodiment of a device includes: an input interface configured to receive a selection of a first status indicator for a first communication channel and a selection of a second status indicator for a second communication channel, the communication channels including voice calls and text messages; mapping circuit configured to associate automated response messages, with status indicators for the communication channels; and a connection handling circuit configured to identify a contact requesting communication through a first communication channel and identify a first status indicator for the first communication channel, wherein the connection handling circuit automatically responds to the contact automatically with the first automated response message.

An embodiment of a graphical user interface produced by and displayed on a display of a computing device includes: a first section configured to display connection channels including a voice channel and a text channel; a first subsection included in the first section, the first subsection configured to present selectable status indicators associated with the voice channel; a second subsection included in the first section, the second subsection configured to present selectable status indicators associated with the text channel, where a first status indicator selected for the voice channel is different from a second status indicator selected for the text channel, where the first status indicator is used to select an automated response message for a connection request on the voice channel.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular connection channels such as voice calls. However, it should be noted that the techniques of the present invention apply to a wide variety of different connection channels including text messages, email messages, multimedia calls, social networking interactions, etc. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Connection handling mechanisms in devices such as mobile devices are typically limited in a variety of manners. Mode-based connection handling mechanisms allow a device to enter a state such as an airplane mode, silent mode, do not disturb mode, etc. These modes globally suppress all radio communications in general, all notifications in general, and/or all audio in general.

For example, a do not disturb mode may silence all connection requests and silence all subsequent notifications of voicemail, text, and email messages. However, a caller would not have any information about what the receiver is doing. An airplane mode would turn off wireless radios so that connection requests cannot even be received. The receiver would often not even know whether calls were attempted by a caller. Some applications allow a user to set automated response messages for all connection requests from a particular channel. For example, all text messages received at the device would be handled by sending a generic call handling reply. In some instances, all connection requests on a particular channel may be handled with a universal message. The connection request initiator or caller receives little information about the receiver. In some examples, a sender of a text message does not know if the receiver is in a short meeting, on vacation, asleep, or in a theater. The receiver has little ability to automatically convey any useful information to the sender using conventional mechanisms. In some instances, the receiver may set a universal automated response message that is provided to all senders, but the universal automated response message is necessarily generic.

Consequently, various embodiments of the present invention provide mechanisms for enhancing connection handling. A connection handling system may be included in a device such as a mobile device to allow selection of a status indicator. The status indicator may be visible to most callers and invisible to other contacts and callers. More detailed status indicator information may be available to a white list of contacts such as close friends and family. For example, a status indicator visible to contacts and other callers may show that a user is unavailable for the next two hours. The status indicator visible to contacts in a whitelist of contacts may show that the user is at a lunch meeting with a coworker. In some instances, status indicators may not be visible to anyone, and may only be provided in user-specific automated response messages.

According to various embodiments, the connection handling system allows status indicators to be set on a per channel basis. For example, a user in a meeting may select a status of busy for phone calls and a status of available for text messages and email messages. A user may also configure particular status indicators with rules or rule sets. In another example, a status indicator of busy may trigger automated response messages to connection initiators such as callers. The automated response messages may include the status indicator. A status indicator of on vacation may trigger automated response messages to connection initiators with a text message or an audible message noting that the user may be unreachable for several days. Response messages may also be configured on a per channel basis. For example, a busy status for voice calls may trigger a message directing a caller to send a text message or email message instead. On the other hand, a busy status for text or email messages may trigger no response at all.

In some examples, users may also configure contact groups including a whitelist of contacts. Whitelisted contacts may be treated differently from other contacts. In some examples, whitelisted contacts may be close family and friends that are provided with an override code in automated response messages. The override code allows the whitelisted contact to break through to a user even if the user has selected a status of busy or unavailable. In some examples, the whitelisted contact could include the override code in the header or body of a message, or enter the override code after dialing a number. The override code may be dynamic and vary based on a user, status indicator, and/or communication channel. In some examples, only particular users may be provided with override codes and only for particular status indicators.

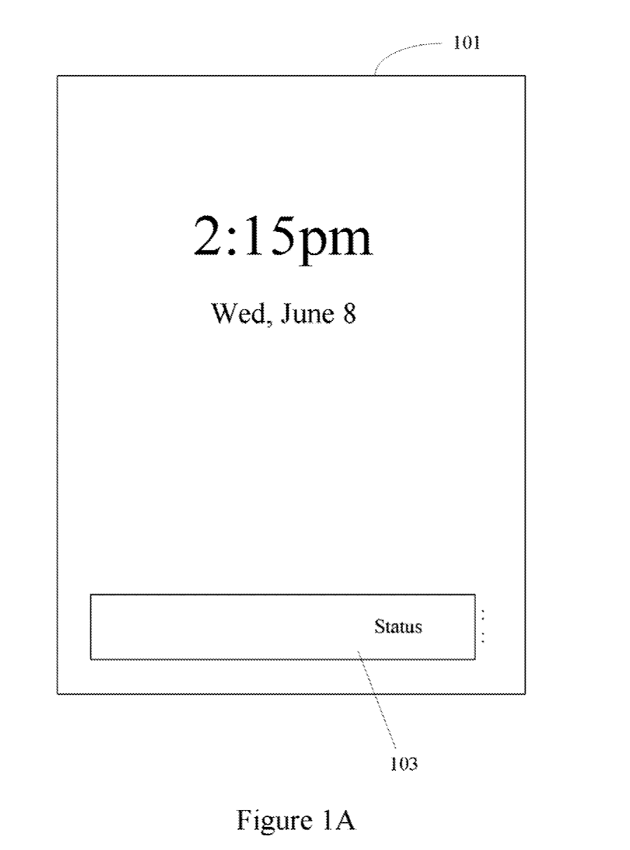

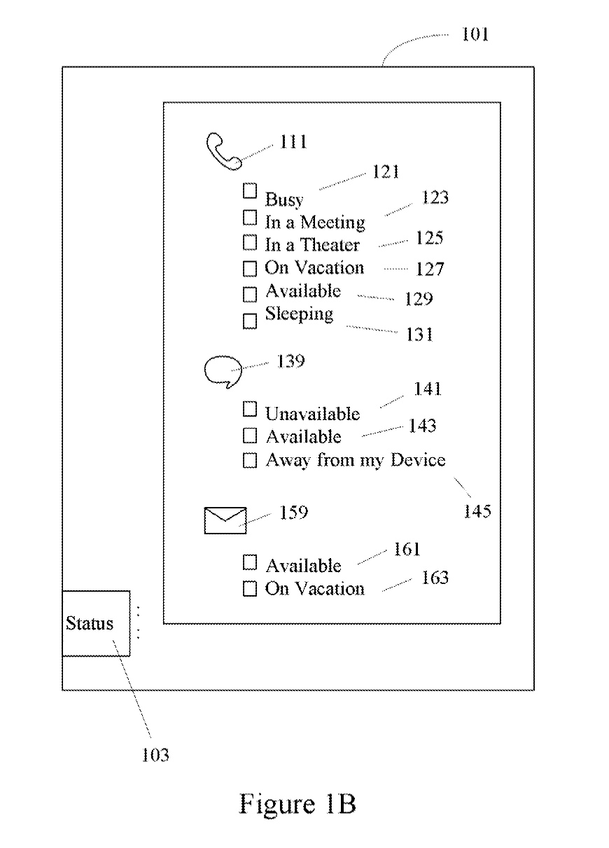

FIGS. 1A-1B illustrate one example of a status screen that may be used with a connection handling system. According to various embodiments, a status screen 101 may be a standalone screen, integrated with a mobile device lockscreen, or included as a portion of another application screen. In particular embodiments, a status screen 101 may be shown by activating a status screen trigger 103 through user interface interaction. According to various embodiments, the status screen 101 is triggered to show multiple communication channels including voice calls 111, text messages 113, and email messages 115. Status indicators may be selected for each of the communication channels.

According to various embodiments, voice call 111 status indicators may include entries such as busy 121, in a meeting 123, in a theater 125, on vacation 127, available 129, and sleeping 131. Text message 139 status indicators may include the same entries or similar entries such as unavailable 141, available 143, and away from my device 145. Email 159 status indicators may include entries such as available 161, and on vacation 163. A user of a device may select the same or different status indicators for each of the different communication channels. Default status indicators of available may correspond to normal volume alerts and notifications. Busy status indicators of unavailable or in a meeting may correspond to suppressed alerts and notifications while also providing the capability to send automated response messages to a connection initiator such as a caller or sender.

Various embodiments of the present invention recognize that allowing customized status selection on a per channel basis allows suppression of particular alerts and notifications appropriate for the particular channel. In some examples, a user in a theater may be unavailable for voice calls while remaining available for text and email messages. In other examples, a user driving in a car may be unavailable for text and email messages but may be available for hands-free voice calls. According to various embodiments, status indicators may be automatically selected by a device. In some examples, a device may detect a particular user activity based on time and device sensor data. Based on the time, the device may automatically select a sleep status for multiple channels. Based on the activation of airplane mode, the device may automatically select an “on a flight” status for multiple channels and have automated response messages triggered from a remote server or cloud based service. Based on data from an accelerometer, the device may determine that the user is currently jogging and set an appropriate status.

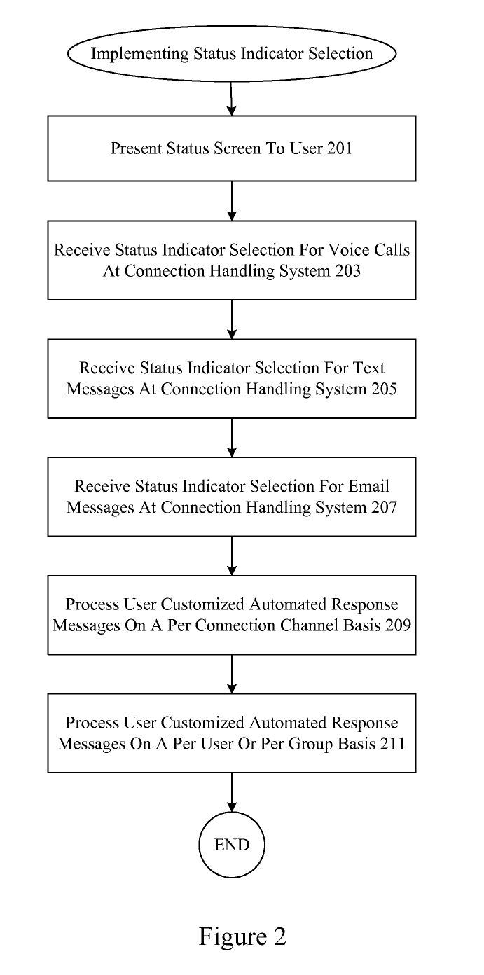

FIG. 2 illustrates one example of a technique for implementing status indicator selection. At 201, status screen is presented to a user. The status screen may be included in an application screen and implemented at the application level or integrated with an operating system and provided in a lock screen. The status screen may be automatically presented or presented after some interaction from the user. At 203, the connection handling system receives a status indicator selection for voice calls. At 205, the connection handling system receives a status indicator selection for text messages. At 207, the connection handling system receives a status indicator selection for email messages. At 209, a user can customize automated response messages on a per connection channel basis. The automated response messages may be transmitted on the same connection channel or on a different connection channel. For example, connection requests received on a voice call or video chat channel can be handled with messages on a text message channel indicating that the user cannot take the call at that particular moment. Alternatively, messages received on a text message connection channel can be handled with response messages on the same text message channel.

According to various embodiments, automated response messages may also be set on a per user or per group basis at 211. Family members, friends, and co-workers may receive particular defined automated response messages. Friends may receive a message indicating that a user is unavailable while co-workers may receive a message indicating unavailability along with the duration of unavailability.

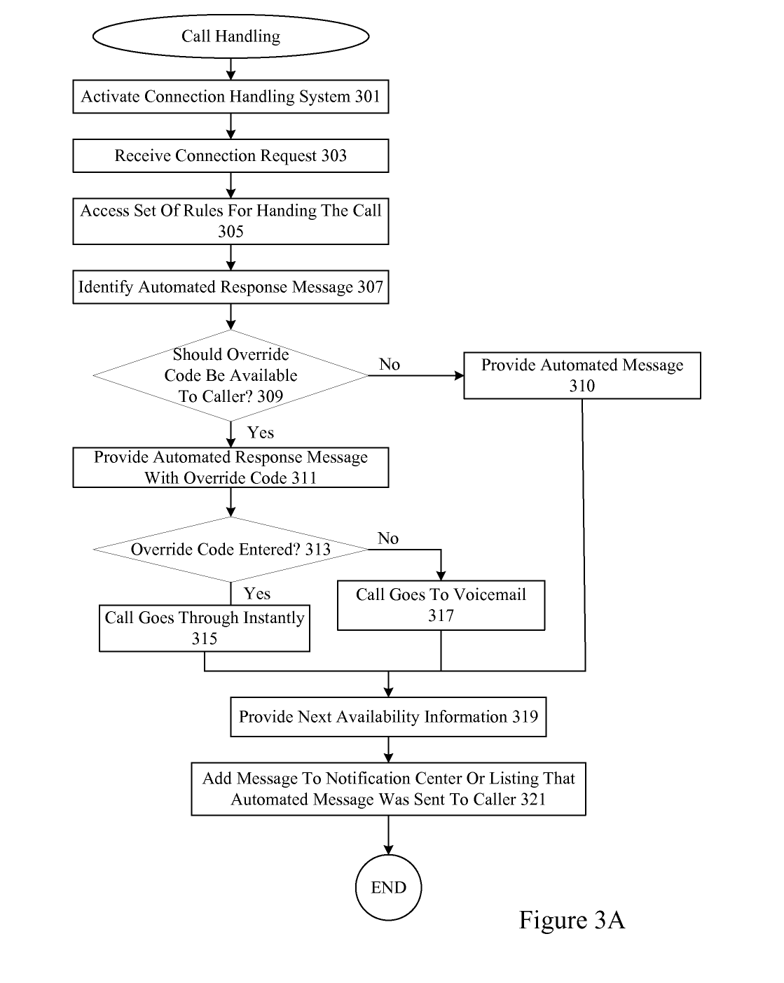

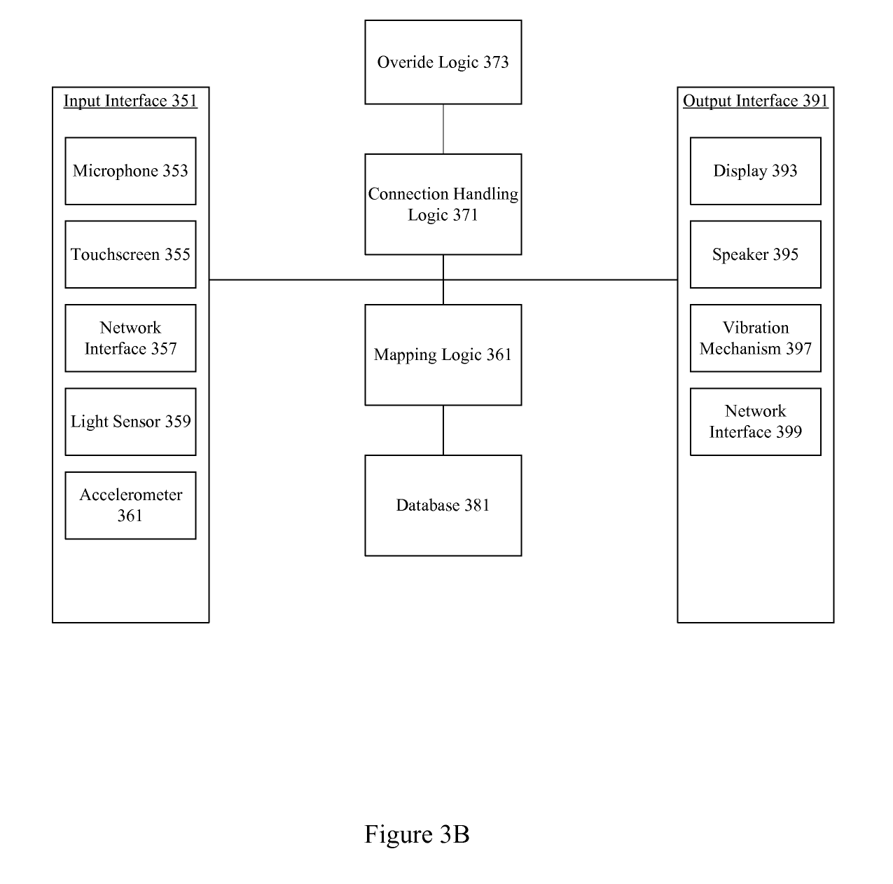

FIG. 3A illustrates one example of call handling. At 301, a user activates a connection request handling system upon setting status indicators for various connection channels. At 303, the user receives a connection request such as a voice call. At 305, a set of rules for handling the call is accessed based on the selected status indicator, the connection channel, and the caller. At 307, an automated response message for the status indicator, the connection channel, and/or the caller is identified. At 309, it is determined if an override code should be made available to the caller. If an override code should be made available at 309, the override code is included in the automated response message at 311. If the override code should not be made available, an automated message can be provided at 310 without an override code.

The override code would allow the caller to breakthrough to the user by alerting the user despite any alert or notification suppression configured by the connection request handling system. The override code may be included in a header or body of the automated response message or may even be included in a separate automated response message. In some instances, the override code may be sent on the same or different channel. In some embodiments, the override code is included in a voice mail message for the caller and the caller has the option to enter the code to interrupt the user. If an override code is entered at 313, the call goes through instantly at 315 regardless of ringer suppression and alert suppression settings on a device. If the override code is not entered at 313, the call may go to voice mail at 317. In some examples, regardless of whether an override code is transmitted, time of next availability information may be sent to the caller. For example, an expected meeting end time may be transmitted to the caller in the automated response message at 319. A message may be added to a notification center or listing at 321 to show that the automated response message was sent to the caller.

FIG. 3B illustrates one example of a device configured for connection handling. A device may be a smartphone, tablet, personal computer, television, smartwatch, pendant, etc. According to various embodiments, the device includes an input interface 351 for a connection handling system to receive data and/or instructions. In particular embodiments, the input interface 351 can include a microphone 353, a touchscreen 355, network interface 357, light sensor 359, accelerometer 361, etc. In some examples, the connection handling system may receive automated response messages manually entered on a touchscreen 355 or obtained from a network over network interface 357. In other examples, automated response messages may be received by using a microphone 353. The automated response messages may be associated with particular users, channels, etc., by using mapping logic 361 and stored in a database 381. According to various embodiments, mapping logic may be implemented using application layer software, kernel layer software, firmware, programmable logic devices, application specific integrated circuits (ASICs), hardwired circuitry, etc.

In some examples, the mapping logic 361 and other logic of the connection handling system such as connection handling logic 371 and override logic 373 may be implemented on a remote server or in the cloud. Similarly, data may be stored on a remote server or in the cloud instead of in database 381.

The input interface can also be used to receive status indicator selections as well as connection requests. According to various embodiments, status indicator selections can be manually selected by a user. For example, a sleep status for a voice channel may be manually selected using touchscreen 355 or microphone 353 input. In other examples, a sleep status may be automatically selected based on information obtained from sensors such as light sensor 359, accelerometer 361, clocks, etc. For example, a device may automatically select a sleep status for a voice channel.

Connection requests may be received over wireless connections and processed by connection handling logic 371. The connection handling logic 371 can access mapping logic 361 and database 381 to determine whether to notify a user through output interface 391, automatically respond to the connection request, etc. The connection handling logic 371 may also access override logic 373 to determine whether an appropriate override code has been entered.

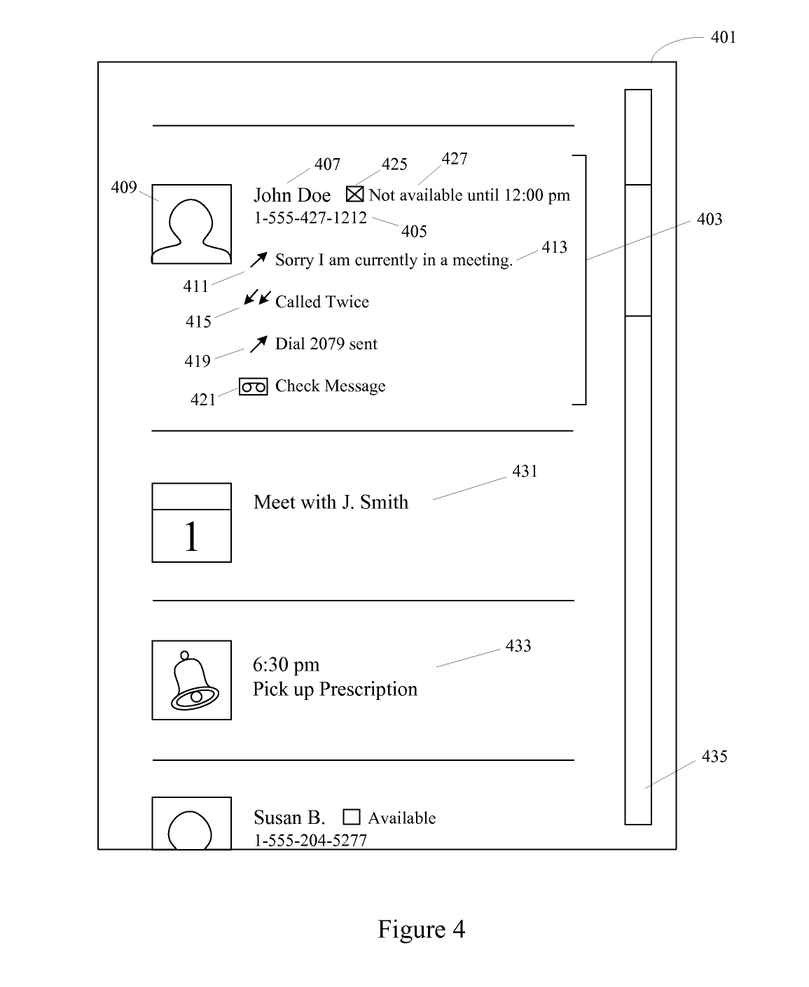

FIG. 4 illustrates one example of a notification system. According to various embodiments, whenever a user receives a connection request such as a call, a text message, an email message, a video chat request, etc., an entry 403 is added to a notification system 401. The entry may include caller information such as a phone number 405, name 407, profile pictures 409. The entry may also include an indicator 411 showing whether an automated response message was sent as well as the automated response message content 413. According to various embodiments, the notification system entry may also show a tally 415 with information on whether the caller attempted multiple connection requests on one or more channels. In one example, the entry may show that an automated response message was sent to a caller who attempted to call twice. An override code 419 sent to the caller can be included. In some instances, particular override codes may be assigned to particular callers on a permanent or semi-permanent basis. A message left by the caller 421 may also be accessed by way of the notification system.

According to various embodiments, the notification system may also show the current status of the caller 425, e.g. whether the caller is available, busy, in a meeting, etc. The caller's next time of availability 427 may also be shown. The caller's availability may be gleaned from shared calendars or provided by the caller during the connection request. The notification system may also include other entries that may or may not be related to connection requests. For example, the notification system may include task and calendar reminders 431, alarm indicators 433, etc. In some examples, a user can use a scroll bar 435 to scroll through various entries in the notification system.

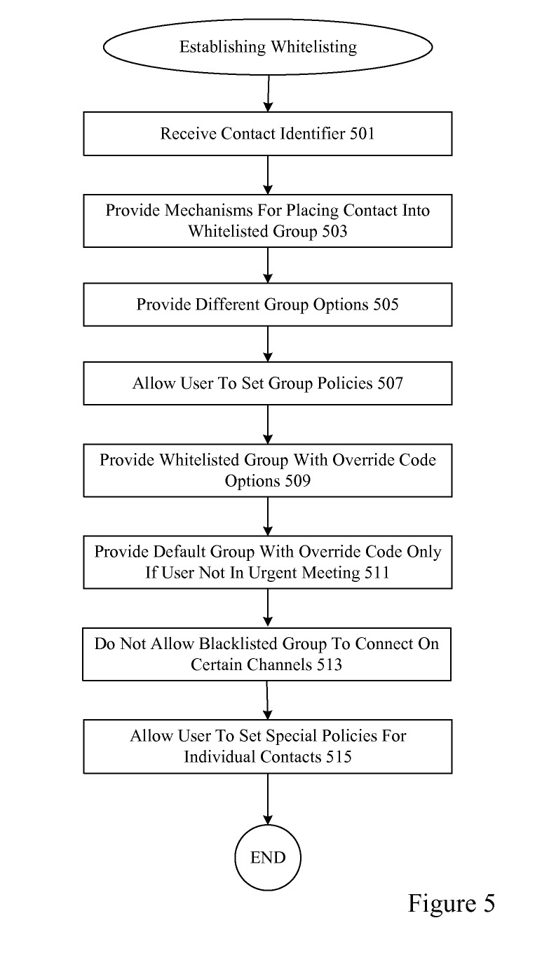

FIG. 5 illustrates one example of whitelisting. According to various embodiments, whitelisting allows a user to place certain contacts in different classes or groups to allow application of different policies for particular contacts. For example, contacts grouped into a close friends and family group may also be provided with override codes while contacts grouped into an acquaintance group may be sent to voicemail automatically regardless of any selected status indicator. According to various embodiments, a connection request handling system receives a particular contact identifier at 501 and provides mechanisms from placing the contact associated with the contact identifier into a whitelisted group at 503. In particular exemplary embodiments, a whitelisted group is merely any group that may be provided with preferential treatment for connection requests. In some examples, a whitelisted group may be a close friends and family group or a child care provider group that is allowed to reach the user even if the user is busy or in a meeting. Alternatively, the whitelisted group may also be provided with override code options or options to interrupt the user by making additional unanswered calls or by sending multiple unanswered messages.

According to various embodiments, different group options may be provided to a user at 505. The groups may include a whitelisted group, a default group, and a blacklisted group. Alternatively, the groups may be given names like a friends group, a co-workers group, a family group, a school group, etc. At 507, group policies may be set by the user. In particular exemplary embodiments, the whitelisted group may always be provided with override code options at 509. The default group may be provided with override code options only if the user is not in an urgent meeting at 511. The blacklisted group may not be allowed to connect with the user under any circumstances on certain channels at 513. For example, a blacklisted group may include telemarketers that are not allowed to connect to the user through voice channels, although they still may be allowed to send email messages.

In some examples, special policies may be set for individual contacts at 515. For example, a babysitter may be provided with override codes during babysitting hours but may be treated as a regular contact during all other hours.

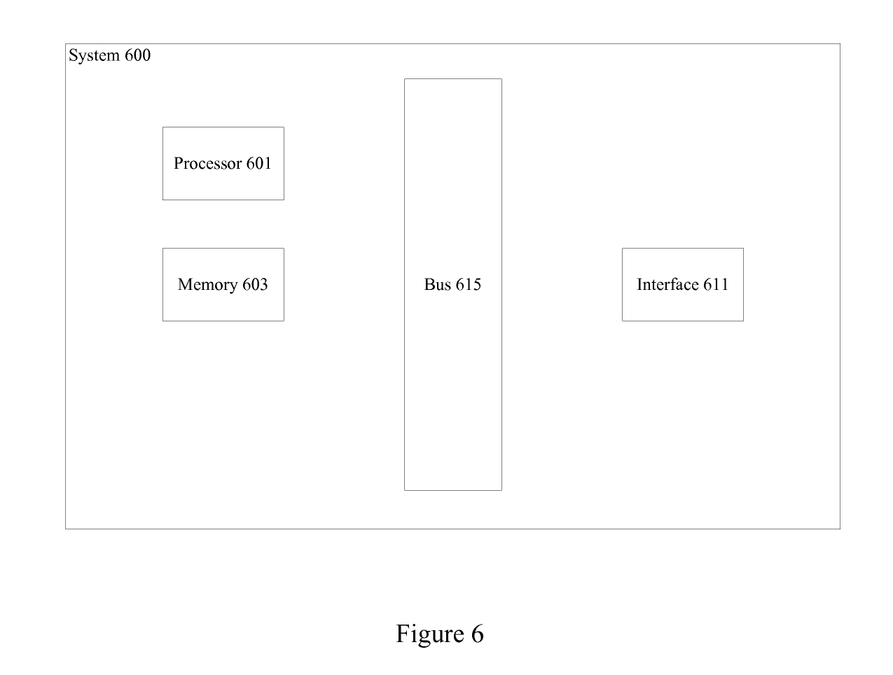

FIG. 6 illustrates one example of a system or device. According to particular embodiments, a system 600 suitable for implementing a connection handling system includes a processor 601, a memory 603, an interface 611, and a bus 615 (e.g., a PCI bus or other interconnection fabric). The system 600 may also include one or more wireless transceivers. When acting under the control of appropriate software or firmware, the processor 601 is configured to receive connection requests and process the connection requests based on status indicator, connection channel, and contact characteristics. Memory 603 may include random access memory or other solid state memory devices, volatile, and non-volatile memory.

Memory 603 may store modules, instructions, data structures, display information, etc. Memory 603 may be located with the processor 601, integrated with the processor 601, or located remotely from the processor 601. The processor 601 may include one or many processor cores in a system and may or may not be integrated with a graphics processor. Various specially configured devices can also be used in place of a processor 601 or in addition to processor 601. For example, various microcontrollers may be used in place of a processor. The interface 611 is typically configured to send and receive data. The interface may be connected to one or more input interfaces such as touchscreens, sensors, scopes, receivers, mice, keyboards, and physical buttons, as well as to output interfaces such as displays, speakers, and transmitters.

The interface 611 may also be connected to network interfaces such as ethernet interfaces, frame relay interfaces, cable interfaces, cellular interfaces, and wireless interfaces. According to various embodiments, interfaces themselves may also include independent processors and memory. The independent processors may control such communications intensive tasks such as signal processing and management.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than in a restrictive sense, and all such modifications are intended to be included within the scope of invention.

1. A method comprising:
receiving a selection of a first status indicator for a first communication channel;
receiving a selection of a second status indicator for a second communication channel;
receiving a connection request on the first communication channel from a contact;
selecting a first automated response message based on the first status indicator and the first communication channel, wherein the first automated response message corresponds to the first status indicator for the first communication channel; and
automatically responding to the contact with the first automated response message by using a processor included in the device.

2. The method of claim 1, wherein the first status indicator is received from the user while the device is locked.

3. The method of claim 1, wherein alerts and notifications are suppressed on the device based on the first status indicator for the first communication channel.

4. The method of claim 1, wherein information associated with the contact is logged after automatically responding to the contact.

5. The method of claim 1, wherein an override code is provided to the contact if the contact is included in a contact whitelist.

6. The method of claim 5, wherein use of the override code by the contact activates alerts on the device of the user.

7. The method of claim 6, wherein the override code is entered by the contact.

8. The method of claim 6, wherein the override code is included by the contact in a message to the user.

9. The method of claim 5, wherein a second automated response message based on the second status indicator and the second communication channel is selected for a second contact, wherein the second automated response message corresponds to the second status indicator for the second communication channel.

10. A device comprising:
a processor; and
a memory coupled to the processor, wherein the memory is configured to store one or more programs comprising:
instructions for receiving a selection of a first status indicator for a first communication channel, the selection received from a user of a device;
instructions for receiving a selection of a second status indicator for a second communication channel;
instructions for receiving a connection request on the first communication channel from a contact;
instructions for selecting a first automated response message based on the first status indicator and the first communication channel, wherein the first automated response message corresponds to the first status indicator for the first communication channel; and
instructions for automatically responding to the contact with the first automated response message.

11. The device of claim 10, wherein the first status indicator is received from the user while the device is locked.

12. The device of claim 10, wherein alerts and notifications are suppressed on the device based on the first status indicator for the first communication channel.

13. The device of claim 10, wherein information associated with the contact is logged after automatically responding to the contact.

14. The device of claim 10, wherein an override code is provided to the contact if the contact is included in a contact whitelist.

15. The device of claim 14, wherein use of the override code by the contact activates alerts on the device of the user.

16. The device of claim 15, wherein the override code is entered by the contact.

17. The device of claim 15, wherein the override code is included by the contact in a message to the user.

18. The device of claim 14, wherein a second automated response message based on the second status indicator and the second communication channel is selected for a second contact, wherein the second automated response message corresponds to the second status indicator for the second communication channel.

19. A non-transitory processor-readable medium with an executable program stored thereon, wherein the program when executed on a processor performs a method comprising:
receiving a selection of a first status indicator for a first communication channel, the selection received from a user of a device;
receiving a selection of a second status indicator for a second communication channel;
receiving a connection request on the first communication channel from a contact;
selecting a first automated response message based on the first status indicator and the first communication channel, wherein the first automated response message corresponds to the first status indicator for the first communication channel; and
automatically responding to the contact with the first automated response message.

20. The non-transitory processor-readable medium of claim 19, wherein the first status indicator is received from the user while the device is locked.

21. The non-transitory processor-readable medium of claim 19, wherein alerts and notifications are suppressed on the device based on the first status indicator for the first communication channel.

22. The non-transitory processor-readable medium of claim 19, wherein information associated with the contact is logged after automatically responding to the contact.

23. The non-transitory processor-readable medium of claim 19, wherein an override code is provided to the contact if the contact is included in a contact whitelist.

24. The non-transitory processor-readable medium of claim 23, wherein use of the override code by the contact activates alerts on the device of the user.

25. The non-transitory processor-readable medium of claim 24, wherein the override code is entered by the contact on a keypad.

26. The non-transitory processor-readable medium of claim 24, wherein the override code is included by the contact in a message to the user.

27. The non-transitory processor-readable medium of claim 23, wherein a second automated response message based on the second status indicator and the second communication channel is selected for a second contact, wherein the second automated response message corresponds to the second status indicator for the second communication channel.

28. A device comprising:
an input interface configured to receive a selection of a first status indicator for a first communication channel and a selection of second status indicator for a second communication channel, the plurality of communication channels including voice calls and text messages;
mapping logic configured to associate a plurality of automated response messages, with a plurality of status indicators a the plurality of communication channels;
connection handling logic configured to identify a contact requesting communication through a first communication channel and identify a first status indicator for the first communication channel, wherein the connection handling logic automatically responds to the contact automatically with the first automated response message.

29. A graphical user interface produced by and displayed on a display of a computing device, the graphical user interface comprising:
a first section configured to display a plurality of connection channels including a voice channel and a text channel;
a first subsection included in the first section, the first subsection configured to present a plurality of selectable status indicators associated with the voice channel;
a second subsection included in the first section, the second subsection configured to present a plurality of selectable status indicators associated with the text channel, wherein a first status indicator selected for the voice channel is different from a second status indicator selected for the text channel, wherein the first status indicator is used to select an automated response message for a connection request on the voice channel.

30. The graphical user interface further comprising a third subsection included in the first section, the third subsection configured to present a plurality of selectable status indicators associated with an email channel.
